(19) United States
(12) Patent Application Publication
(10) Pub. No.: US 2026/0211826 A1
(43) Pub. Date: Jul. 23, 2026

(54) DIRECT MEMORY ACCESS DESCRIPTOR PROCESSING METHOD, SYSTEM, AND APPARATUS, DEVICE, AND MEDIUM

(71) Applicant: IEIT SYSTEMS (BEIJING) CO., LTD., Beijing (CN)

(72) Inventors: Junkai LIU, Beijing (CN); Yanwei WANG, Beijing (CN); Rengang LI, Beijing (CN)

(21) Appl. No.: 19/139,803

(22) PCT Filed: Dec. 15, 2023
(86) PCT No.: PCT/CN2023/139261

§ 371 Date: Jun. 16, 2025

(30) Foreign Application Priority Data
Jul. 19, 2023 (CN) 202310884534.4

(51) Int. Cl. G06F 13/28

(52) U.S. Cl. CPC G06F 13/28; G06F 2213/28

(57) ABSTRACT

The present disclosure discloses a direct memory access descriptor processing method, a system, an apparatus, a device and a medium, and relates to the technical field of field programmable and gate array, including acquiring a first direct memory access descriptor to be processed transmitted by a target accelerator function unit; acquiring an existing second direct memory access descriptor; if the first direct memory access descriptor and the second direct memory access descriptor can be merged, the first direct memory access descriptor is merged into the second direct memory access descriptor; if the merging operation is not terminated, returning to the steps of acquiring the first direct memory access descriptor to be processed transmitted by the target accelerator function unit and the subsequent steps; if the merging operation is terminated, the second direct memory access descriptor is transmitted to the IP core of PCI-E for processing. According to the present disclosure, the field programmable gate array may process a plurality of direct memory access descriptors at one time, and the computing capacity is improved.

### CROSS-REFERENCE TO RELATED APPLICATION

The present disclosure claims the priority of Chinese patent application filed in CNIPA on Jul. 19, 2023, with the application number of 202310884534.4 and the application name of “DIRECT MEMORY ACCESS DESCRIPTOR PROCESSING METHOD, SYSTEM, AND APPARATUS, DEVICE AND MEDIUM”, the entire contents of which are incorporated into the present disclosure by reference.

### FIELD

The present disclosure relate to the technical field of field programmable and gate arrays, and more specifically relate to a direct memory access descriptor processing method, a system, and an apparatus, a device and a medium.

### BACKGROUND

With the increasing demand for computing power by cloud computing, artificial intelligence and other technologies, the heterogeneous accelerated computing unit of Central Processing Unit (CPU) combined with Field Programmable Gate Array (FPGA) accelerator card has gradually become the mainstream computing unit in data centers. And in the FPGA, an Accelerator Functional Unit (AFU) stores the calculation results in Random Access Memory (RAM), the accelerator function unit sends a Direct Memory Access (DMA) descriptor to a port 1 of the Intellectual Property core (IP core) of peripheral component interconnect express (PCI-E) after each calculation. A port 3 of the IP core of peripheral component interconnect express reads the result data from the random access memory into the host memory, and after the memory access operation is completed, a port 2 of the IP core of peripheral component interconnect express outputs the completion information to the accelerator function unit.

However, as the computational speed of the field-programmable gate array (FPGA) accelerator card continues to increase and the volume of computational result data grows, each computation requires transferring the result data generated within the FPGA to the host memory. The accelerator functional unit rapidly sends direct memory access (DMA) descriptors to port 1 of the IP core of peripheral component interconnect express. However, the processing efficiency of the IP core of peripheral component interconnect express for DMA descriptors is limited. An excessive number of DMA descriptors can reduce the efficiency of DMA transfers, and the delay time for port 2 of the IP core of peripheral component interconnect express to output completion information will increase. This leads to the accumulation of computational result data, exhausting the free pointers and causing the accelerator functional unit to pause computation, thereby reducing the overall computational capability of the FPGA accelerator card.

### SUMMARY

The purpose of the present disclosure is to provide a direct memory access descriptor processing method, which can solve the technical problem of how to improve the computing power of FPGA to a certain extent. The present disclosure also provides a direct memory access descriptor processing system, a device, an electronic device and a non-transitory readable storage medium.

According to a first aspect of embodiments of the present disclosure, a direct memory access descriptor processing method is provided, including:
acquiring a first direct memory access descriptor to be processed transmitted by a target accelerator function unit in a field programmable gate array (FPGA);
acquiring an existing second direct memory access descriptor;
determining whether the first direct memory access descriptor and the second direct memory access descriptor can be merged;
if the first direct memory access descriptor and the second direct memory access descriptor can be merged, merging the first direct memory access descriptor into the second direct memory access descriptor;
determining whether to terminate the merging operation;
if the merging operation is not terminated, returning to execute a step of acquiring the first direct memory access descriptor to be processed transmitted by the target accelerator function unit in the FPGA and subsequent steps;
if the merging operation is terminated, transmitting the second direct memory access descriptor to an Intellectual Property core (IP core) of peripheral component interconnect express (PCI-E) in the FPGA for processing.

In some embodiments, determining whether the first direct memory access descriptor and the second direct memory access descriptor can be merged includes:
acquiring a last merged tail direct memory access descriptor in the second direct memory access descriptor;
determining whether the tail direct memory access descriptor and the first direct memory access descriptor can be merged;
determining that the first direct memory access descriptor and the second direct memory access descriptor can be merged if the tail direct memory access descriptor and the first direct memory access descriptor can be merged;
determining that the first direct memory access descriptor and the second direct memory access descriptor cannot be merged if the tail direct memory access descriptor and the first direct memory access descriptor cannot be merged.

In some embodiments, determining whether the tail direct memory access descriptor and the first direct memory access descriptor can be merged includes:
parsing a first source address, a first destination address and a first data length value in the tail direct memory access descriptor;
calculating a sum of the first source address and the first data length value as a first expected source address;
calculating a sum of the first destination address and the first data length value as a first expected destination address;
parsing a second source address and a second destination address in the first direct memory access descriptor;
if the first expected source address is consistent with the second source address and the first expected destination address is consistent with the second destination address, determining that the tail direct memory access descriptor and the first direct memory access descriptor can be merged;
if the first expected source address is inconsistent with the second source address and/or the first expected destination address is inconsistent with the second destination address, determining that the tail direct memory access descriptor and the first direct memory access descriptor cannot be merged.

In some embodiments, after merging the first direct memory access descriptor into the second direct memory access descriptor, the method further includes:
storing the first direct memory access descriptor as a latest tail direct memory access descriptor.

In some embodiments, determining whether the first direct memory access descriptor and the second direct memory access descriptor can be merged includes:
parsing a third source address, a third destination address and a third data length value in the second direct memory access descriptor;
calculating a sum of the third source address and the third data length value as a second expected source address;
calculating a sum of the third destination address and the third data length value as a second expected destination address;
parsing a second source address and a second destination address in the first direct memory access descriptor;
determining that the first direct memory access descriptor and the second direct memory access descriptor can be merged if the second expected source address is consistent with the second source address and the second expected destination address is consistent with the second destination address;
determining that the first direct memory access descriptor and the second direct memory access descriptor cannot be merged if the second expected source address is inconsistent with the second source address and/or the second expected destination address is inconsistent with the second destination address.

In some embodiments, merging the first direct memory access descriptor into the second direct memory access descriptor includes:
parsing a third data length value in the second direct memory access descriptor;
parsing a second data length value in the first direct memory access descriptor;
calculating a sum of the third data length value and the second data length value;
keeping a source address and a destination address of the second direct memory access descriptor unchanged, and taking the sum as a latest data length value of the second direct memory access descriptor.

In some embodiments, an initial second direct memory access descriptor is empty, and setting a merging result of the initial second direct memory access descriptor and a first one of the first direct memory access descriptor of the merging operation as the first direct memory access descriptor itself.

In some embodiments, after acquiring the first direct memory access descriptor to be processed transmitted by the target accelerator function unit in the FPGA, and before acquiring the existing second direct memory access descriptor, the method further includes:
determining whether the first direct memory access descriptor is the first one of the direct memory access descriptor of the merging operation;
if the first direct memory access descriptor is the first one of the direct memory access descriptor of the merging operation, taking the first direct memory access descriptor as the second direct memory access descriptor, and returning to execute steps after acquiring the first direct memory access descriptor to be processed transmitted by the target accelerator function unit in the FPGA;
if the first direct memory access descriptor is not the first one of the direct memory access descriptor of the merging operation, executing steps after acquiring the existing second direct memory access descriptor.

In some embodiments, the method further including:
recording target identification information of each of the first direct memory access descriptors of the merging operation.

In some embodiments, after transmitting the second direct memory access descriptor to the IP core of peripheral component interconnect express in the FPGA for processing, the method further includes:
receiving first information representing that processing of the second direct memory access descriptor completes transmitted by the IP core of peripheral component interconnect express;
transmitting, based on the target identification information, second information representing that the processing of a corresponding first direct memory access descriptor has been completed to the target accelerator function unit.

In some embodiments, transmitting, based on the target identification information, the second information representing that the processing of the corresponding first direct memory access descriptor has been completed to the target accelerator function unit includes:
parsing identification information of the second direct memory access descriptor in the second information;
if the identification information of the second direct memory access descriptor is consistent with the target identification information, executing a step of transmitting, based on the target identification information, the second information representing that the processing of the corresponding first direct memory access descriptor has been completed.

In some embodiments, recording the target identification information of each of the first direct memory access descriptors of the merging operation includes:
if the identification information among each of the first direct memory access descriptors is consecutive, recording the first identifier of the first one of the first direct memory access descriptor in the merging operation and recording numerical values of the first direct memory access descriptors merged in the merging operation;
taking the first identifier and the numerical values as the target identification information.

In some embodiments, transmitting the second direct memory access descriptor to the IP core of peripheral component interconnect express in the FPGA for processing includes:
transmitting the second direct memory access descriptor to the IP core of peripheral component interconnect express for processing through a first port of the IP core of peripheral component interconnect express.

In some embodiments, receiving the first information representing that processing of the second direct memory access descriptor completes transmitted by the IP core of peripheral component interconnect express includes:
receiving the first information representing that processing of the second direct memory access descriptor completes transmitted by the IP core of peripheral component interconnect express through a second port of the IP core of peripheral component interconnect express.

In some embodiments, the method further including:
recording a processing state of the first direct memory access descriptor by a state machine.

In some embodiments, after determining whether the first direct memory access descriptor and the second direct memory access descriptor can be merged, the method further includes:
if the first direct memory access descriptor and the second direct memory access descriptor cannot be merged, transmitting the second direct memory access descriptor to the IP core of peripheral component interconnect express for processing, taking the first direct memory access descriptor as the second direct memory access descriptor, and returning to execute a step of acquiring the first direct memory access descriptor to be processed transmitted by the target accelerator function unit in the FPGA and subsequent steps.

According to a second aspect of embodiments of the present disclosure, a direct memory access descriptor processing system is provided, including:
a first acquisition module, configured to acquire a first direct memory access descriptor to be processed transmitted by a target accelerator function unit in a field programmable gate array (FPGA);
a second acquisition module, configured to acquire an existing second direct memory access descriptor;
a first determination module, configured to determine whether the first direct memory access descriptor and the second direct memory access descriptor can be merged; if the first direct memory access descriptor and the second direct memory access descriptor can be merged, merging the first direct memory access descriptor into the second direct memory access descriptor;
a second determination module, configured to determine whether to terminate the merging operation; if the merging operation is not terminated, returning to execute a step of acquiring the first direct memory access descriptor to be processed transmitted by the target accelerator function unit in the FPGA and subsequent steps; if the merging operation is terminated, transmitting the second direct memory access descriptor to an Intellectual Property core (IP core) of peripheral component interconnect express (PCI-E) in the FPGA for processing.

According to a third aspect of embodiments of the present disclosure, a direct memory access descriptor processing apparatus is provided, including:
a first first-in first-out (FIFO) memory connected to a target accelerator function unit in a field programmable gate array (FPGA), configured to store a first direct memory access descriptor to be processed transmitted by the target accelerator function unit;
a merging controller connected to the first FIFO memory and a second FIFO memory, configured to determine whether the first direct memory access descriptor and a second direct memory access descriptor stored in the second FIFO can be merged; merge the first direct memory access descriptor and the second direct memory access descriptor stored in the second FIFO memory if the first direct memory access descriptor and the second direct memory access descriptor can be merged; determine whether to terminate the merging operation; if the merging operation is not terminated, after the first direct memory access descriptor stored in the first FIFO memory is updated, return to execute a step of determining whether the first direct memory access descriptor and the second direct memory access descriptor can be merged and subsequent steps; if the merging operation is terminated, transmit the second direct memory access descriptor stored in the second FIFO memory to an Intellectual Property core (IP core) of peripheral component interconnect express in a field programmable gate array (FPGA) for processing;
the second FIFO memory, configured to store the existing second direct memory access descriptor.

In some embodiments, the apparatus further including:
a direct memory access descriptor register connected to the first FIFO memory and the merging controller, configured to store the first direct memory access descriptor as a latest tail direct memory access descriptor.

In some embodiments, the apparatus further including:
a third FIFO memory connected to the second FIFO memory, configured to record target identification information of each of the first direct memory access descriptors in the merging operation;
a fourth FIFO memory connected to the third FIFO memory, configured to record numerical values of the first direct memory access descriptor merged by the merging operation;
a counter connected to the fourth FIFO memory and the target accelerator function unit, configured to record a quantity value of second information transmitted to the target accelerator function unit, which represents that processing of a corresponding first direct memory access descriptor has been completed.

According to a fourth aspect of embodiments of the present disclosure, an electronic device is provided, including:
a memory, configured to store a computer program;
a processor, configured to implement steps of the direct memory access descriptor processing method according to any one of above when execute the computer program.

According to a fifth aspect of embodiments of the present disclosure, a non-transitory readable storage medium is provided, wherein a computer program is stored in the non-transitory readable storage medium, and the computer program, when executed by a processor, implements steps of the direct memory access descriptor processing method according to any one of above.

The present disclosure provides a direct memory access descriptor processing method, which includes the following steps: acquiring a first direct memory access descriptor to be processed transmitted by a target accelerator function unit in a field programmable gate array (FPGA); acquiring an existing second direct memory access descriptor; determining whether the first direct memory access descriptor and the second direct memory access descriptor can be merged; if the first direct memory access descriptor and the second direct memory access descriptor can be merged, merging the first direct memory access descriptor into the second direct memory access descriptor; determining whether to terminate the merging operation; if the merging operation is not terminated, returning to execute a step of acquiring the first direct memory access descriptor to be processed transmitted by the target accelerator function unit in the FPGA and subsequent steps; if the merging operation is terminated, transmitting the second direct memory access descriptor to an Intellectual Property core (IP core) of peripheral component interconnect express (PCI-E) in the FPGA for processing. According to the present disclosure, the direct memory access descriptors transmitted by the target accelerator function unit may be merged, and the second direct memory access descriptor may be transmitted to the IP core of peripheral component interconnect express for processing. This enables the FPGA to process multiple DMA descriptors in a single operation, thereby improving the processing efficiency of DMA descriptors by the FPGA and consequently enhancing the computational capability of the FPGA. The direct memory access descriptor processing system, apparatus, electronic device, and non-transitory readable storage medium provided by the present disclosure also solve corresponding technical issues.

### BRIEF DESCRIPTION OF THE DRAWINGS

In order to more clearly explain the embodiments of the present disclosure or the technical solution in the prior art, the drawings needed to be used in the description of the embodiments or the prior art will be briefly introduced below. Apparently, the drawings in the following description are only the embodiments of the present disclosure. For persons skilled in the art, other drawings can be acquired according to the provided drawings without expenditure of creative labor.

FIG. 1 is a first schematic diagram of a direct memory access descriptor processing method provided by an embodiment of the present disclosure;

FIG. 2 is a second schematic diagram of a direct memory access descriptor processing method provided by an embodiment of the present disclosure;

FIG. 3 is a schematic structural diagram of a direct memory access descriptor processing system provided by an embodiment of the present disclosure;

FIG. 4 is a schematic structural diagram of a direct memory access descriptor processing apparatus provided by an embodiment of the present disclosure;

FIG. 5 is a schematic diagram of a state machine of a direct memory access descriptor processing apparatus;

FIG. 6 is a schematic diagram of a connection of a FPGA;

FIG. 7 is a schematic diagram of an internal structure of a FPGA;

FIG. 8 is a schematic structural diagram of an electronic device provided by an embodiment of the present disclosure;

FIG. 9 is another structural schematic diagram of an electronic device provided by an embodiment of the present disclosure.

### DETAILED DESCRIPTION

In the following, the technical solution in the embodiments of the present disclosure will be clearly and completely described with reference to the drawings in the embodiments of the present disclosure. Apparently, the described embodiments are only a part of the embodiments of the present disclosure, but not the whole embodiment. Based on the embodiments in the present disclosure, all other embodiments acquired by persons skilled in the art without expenditure of creative labor belong to the protection scope of the present disclosure.

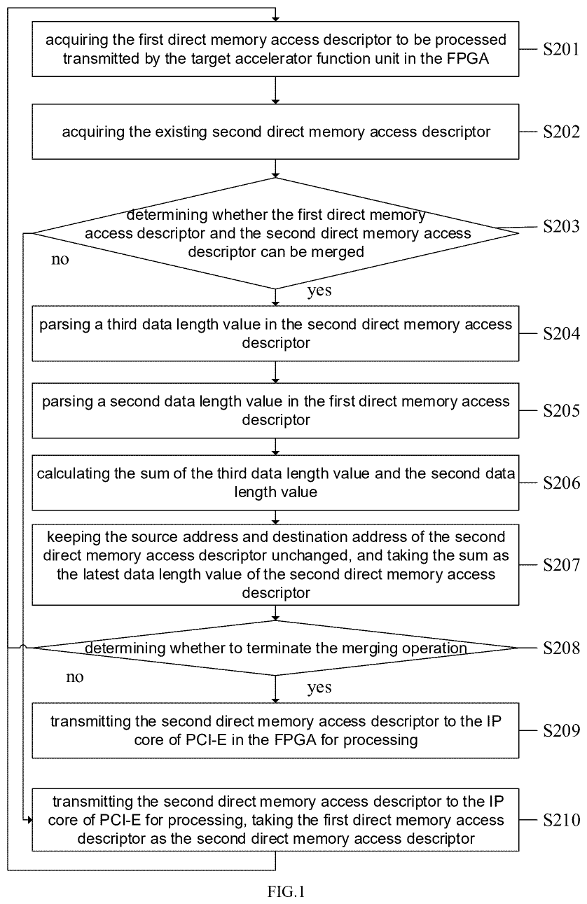

Please refer to FIG. 1, which is a first schematic diagram of a direct memory access descriptor processing method provided by an embodiment of the present disclosure.

A direct memory access descriptor processing method provided by some embodiments of the present disclosure may include the following steps.

Step S101: acquiring a first direct memory access descriptor to be processed transmitted by a target accelerator function unit in a field programmable gate array (FPGA).

In practical application, the first direct memory access descriptor to be processed transmitted by the target accelerator function unit in the FPGA can be acquired first, and a number of the target accelerator function unit and a type of the first direct memory access descriptor can be determined according to actual needs.

Step S102: acquiring an existing second direct memory access descriptor.

In practical application, after acquiring the first direct memory access descriptor, the existing second direct memory access descriptor can also be acquired, so that the first direct memory access descriptor and the second direct memory access descriptor can be merged later.

It should be noted that the existing second direct memory access descriptor is a direct memory access descriptor that existed before the first direct memory access descriptor was received, and the content of the second direct memory access descriptor can be determined at different times during the merging operation. For example, at the beginning of the merging operation, the second direct memory access descriptor can be the first received direct memory access descriptor; After the merging operation, the second direct memory access descriptor refers to the result acquired by merging a plurality of direct memory access descriptors in the process of processing the direct memory access descriptors according to the method of the present disclosure, that is, the merged result acquired before processing the first direct memory access descriptor. In addition, it should be noted that the first direct memory access descriptor and the second direct memory access descriptor in the present disclosure are determined according to the type of merging operation, that is, the first direct memory access descriptor refers to the direct memory access descriptor transmitted by the target accelerator function unit to be involved in the merging operation, while the second direct memory access descriptor refers to the merge result of a single direct memory access descriptor or multiple direct memory access descriptors acquired before the first direct memory access descriptor during the merging operation.

Step S103: determining whether the first direct memory access descriptor and the second direct memory access descriptor can be merged; if the first direct memory access descriptor and the second direct memory access descriptor can be merged, then executing the step S104; if the first direct memory access descriptor and the second direct memory access descriptor cannot be merged, executing the step S107.

Step S104: merging the first direct memory access descriptor into the second direct memory access descriptor.

In practical application, after acquiring the first direct memory access descriptor and the existing second direct memory access descriptor, it may be determined whether the first direct memory access descriptor and the second direct memory access descriptor can be merged. If the first direct memory access descriptor and the second direct memory access descriptor can be merged, the first direct memory access descriptor may be merged into the second direct memory access descriptor, and the latest second direct memory access descriptor can be acquired.

In practical application, in the process of determining whether the first direct memory access descriptor and the second direct memory access descriptor can be merged, in order to rapidly determine the merging, the tail direct memory access descriptor merged by the second direct memory access descriptor can be acquired; determining whether that tail direct memory access descriptor and the first direct memory access descriptor can be merged; it is determined that the first direct memory access descriptor and the second direct memory access descriptor can be merged if the tail direct memory access descriptor and the first direct memory access descriptor can be merged; If the tail direct memory access descriptor and the first direct memory access descriptor cannot be merged, it is determined that the first direct memory access descriptor and the second direct memory access descriptor cannot be merged.

In a specific application scenario, in the process of determining whether the tail direct memory access descriptor can be merged with the first direct memory access descriptor, the first source address, the first destination address and the first data length value in the tail direct memory access descriptor can be parsed; Taking the sum of the first source address and the first data length value as the first expected source address; Taking the sum of the first destination address and the first data length value as the first expected destination address; Parsing a second source address and a second destination address in the first direct memory access descriptor; If the first expected source address is consistent with the second source address and the first expected destination address is consistent with the second destination address, it is determined that the tail direct memory access descriptor and the first direct memory access descriptor can be merged; If the first expected source address is inconsistent with the second source address and/or the first expected destination address is inconsistent with the second destination address, it is determined that the tail direct memory access descriptor and the first direct memory access descriptor cannot be merged. In addition, in practical application scenarios, after the first direct memory access descriptor is merged into the second direct memory access descriptor, the first direct memory access descriptor can be stored as the latest tail direct memory access descriptor, so that the tail direct memory access descriptor can be quickly acquired in the next round of merging operation.

In specific application scenarios, in the process of determining whether the first direct memory access descriptor and the second direct memory access descriptor can be merged, in order to simplify the determination of merging operation, the third source address, the third destination address and the third data length value in the second direct memory access descriptor can be parsed; Taking the sum of the third source address and the third data length value as a second expected source address; Taking the sum of the third destination address and the third data length value as a second expected destination address; Parsing a second source address and a second destination address in the first direct memory access descriptor; It is determined that the first direct memory access descriptor and the second direct memory access descriptor can be merged if the second expected source address is consistent with the second source address and the second expected destination address is consistent with the second destination address; If the second expected source address is inconsistent with the second source address and/or the second expected destination address is inconsistent with the second destination address, it is determined that the first direct memory access descriptor and the second direct memory access descriptor cannot be merged.

Step S105: determining whether to terminate the merging operation; if the merging operation is not terminated, returning to execute step S101. If the merging operation is terminated, executing step S106.

Step S106: transmitting the second direct memory access descriptor to an Intellectual Property core (IP core) of peripheral component interconnect express (PCI-E) in the FPGA for processing.

In practical application, considering that a plurality of direct memory access descriptors may need to be merged, after the first direct memory access descriptor is merged into the second direct memory access descriptor, it can also be determined whether to terminate the merging operation, and if not, step S101 is returned to execute to acquire the latest first direct memory access descriptor for merging processing. If the merging operation is terminated, the final second direct memory access descriptor can be transmitted to the IP core of PCI-E in the FPGA for processing.

It should be noted that the conditions for terminating the merging operation can be determined according to specific application scenarios. For example, the conditions for terminating the merging operation can be that the number of merged direct memory access descriptors in the second direct memory access descriptor reaches a preset number, and in the process, the number values of the first direct memory access descriptors participating in the merging operation can be recorded and updated in real time, and then the merging operation is determined to terminate after the recorded number values reach the preset number. Taking the preset number of five as an example, the merging operation terminates when the five direct memory access descriptors transmitted by the target accelerator function unit are merged. For another example, the condition for terminating the merging operation may be that the target accelerator function unit no longer transmits the first direct memory access descriptor, etc. In this process, the time can be counted after receiving the first direct memory access descriptor transmitted by the target accelerator function unit. If no new first direct memory access descriptor transmitted by the target accelerator function unit is received during the counting to a preset time, then it can be determined that the target accelerator function unit no longer transmits the first direct memory access descriptor. Or it can be determined that the target accelerator function unit no longer transmits the first direct memory access descriptor after receiving the termination instruction of the target accelerator function unit transmission. Or it can be considered that the target accelerator function unit no longer transmits the first direct memory access descriptor if the latest first direct memory access descriptor transmitted by the target acceleration function unit is not received, after completing the merging of the first direct memory access descriptor with the second direct memory access descriptor, and so on, which is not done here in the present disclosure.

Step S107: transmitting the second direct memory access descriptor to the IP core of PCI-E for processing, and taking the first direct memory access descriptor as the second direct memory access descriptor, and returning to execute step S101.

In practical application, if it is determined that the first direct memory access descriptor and the second direct memory access descriptor cannot be merged, the second direct memory access descriptor can be transmitted to the IP core of peripheral component interconnect express for processing, and the first direct memory access descriptor is taken as the second direct memory access descriptor, and the step S101 is returned to execute, to perform the next round of direct memory access descriptor merging operation from the first direct memory access descriptor.

The present disclosure provides a direct memory access descriptor processing method, which includes the following steps: acquiring a first direct memory access descriptor to be processed transmitted by a target accelerator function unit in a FPGA; acquiring an existing second direct memory access descriptor; determining whether the first direct memory access descriptor and the second direct memory access descriptor can be merged; if the first direct memory access descriptor and the second direct memory access descriptor can be merged, merging the first direct memory access descriptor into the second direct memory access descriptor; determining whether to terminate the merging operation; if the merging operation is not terminated, returning to execute a step of acquiring the first direct memory access descriptor to be processed transmitted by the target accelerator function unit in the FPGA and subsequent steps; if the merging operation is terminated, transmitting the second direct memory access descriptor to an IP core of peripheral component interconnect express (PCI-E) in the FPGA for processing. According to the present disclosure, the direct memory access descriptors transmitted by the target accelerator function unit may be merged, and the second direct memory access descriptor may be transmitted to the IP core of peripheral component interconnect express for processing. This enables the FPGA to process multiple DMA descriptors in a single operation, thereby improving the processing efficiency of DMA descriptors by the FPGA and consequently enhancing the computational capability of the FPGA.

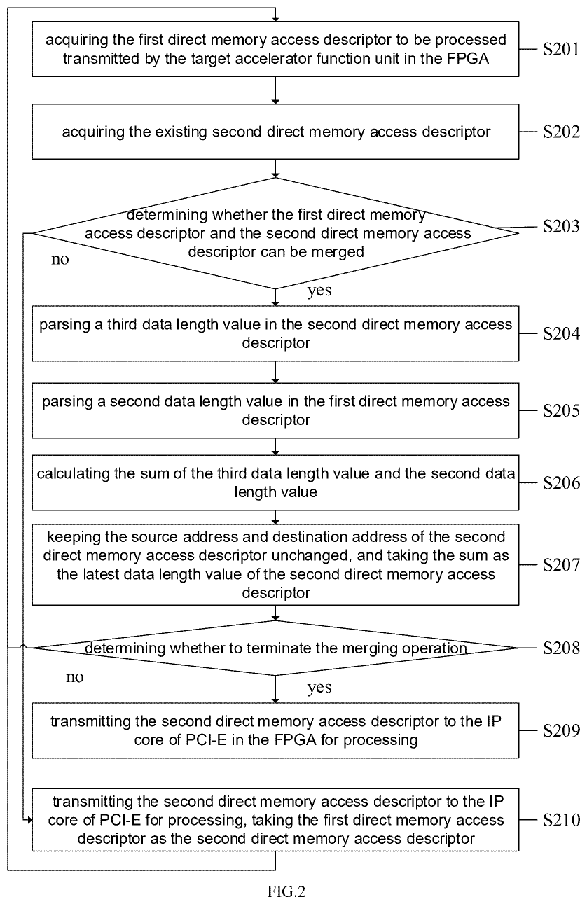

Please refer to FIG. 2, which is a second schematic diagram of a direct memory access descriptor processing method provided by the embodiment of the present disclosure.

On the basis of the foregoing, a direct memory access descriptor processing method provided by some embodiments of the present disclosure may include the following steps.

Step S201: acquiring the first direct memory access descriptor to be processed transmitted by the target accelerator function unit in the FPGA.

Step S202: acquiring the existing second direct memory access descriptor.

Step S203: determining whether the first direct memory access descriptor and the second direct memory access descriptor can be merged; if the first direct memory access descriptor and the second direct memory access descriptor can be merged, executing step S204; if the first direct memory access descriptor and the second direct memory access descriptor cannot be merged, executing step S211.

Step S204: parsing a third data length value in the second direct memory access descriptor.

Step S205: parsing a second data length value in the first direct memory access descriptor.

Step S206: calculating the sum of the third data length value and the second data length value.

Step S207: keeping the source address and destination address of the second direct memory access descriptor unchanged, and taking the sum as the latest data length value of the second direct memory access descriptor.

In practical application, in the process of merging the first direct memory access descriptor into the second direct memory access descriptor, the third data length value in the second direct memory access descriptor can be parsed; Parsing a second data length value in the first direct memory access descriptor; Calculating the sum of the third data length value and the second data length value; Keeping the source address and destination address of the second direct memory access descriptor unchanged, and taking the sum as the latest data length value of the second direct memory access descriptor. Thus, the source address and destination address of the second direct memory access descriptor are the source address and destination address of the first direct memory access descriptor received in the merging process, and the data length value of the second direct memory access descriptor is the sum of the data length values of all the direct memory access descriptors participating in the merging process.

Step S208: determining whether to terminate the merging operation; if the merging operation is not terminated, returning to execute step S201. If the merging operation is terminated, executing step S209.

Step S209: transmitting the second direct memory access descriptor to the IP core of PCI-E in the FPGA for processing.

Step S210: transmitting the second direct memory access descriptor to the IP core of PCI-E for processing, taking the first direct memory access descriptor as the second direct memory access descriptor, and returning to execute step S201.

In practical application, in order to facilitate the execution of the merging operation, the initial second direct memory access descriptor can be set to be empty, and the merge result of the initial second direct memory access descriptor and a first one of the first direct memory access descriptor of the merging operation can be set as the first one of the first direct memory access descriptor itself. For the sake of understanding, it is assumed that there are three direct memory access descriptors which can be merged: a direct memory access descriptor 1, a direct memory access descriptor 2 and a direct memory access descriptor 3. When the direct memory access descriptor 1 is received, the second direct memory access descriptor at this time is initially empty, and the merging result of the direct memory access descriptor 1 and the second direct memory access descriptor is the direct memory access descriptor 1 itself, and the content of the latest second direct memory access descriptor is the same as that of the direct memory access descriptor 1. When the direct memory access descriptor 2 is received, the latest second direct memory access descriptor at this time is equivalent to the direct memory access descriptor 1 itself, so the merging result of the direct memory access descriptor 2 and the latest second direct memory access descriptor is the merging result of the direct memory access descriptor 1 and the direct memory access descriptor 2, and the content of the latest second direct memory access descriptor is the merging result of the direct memory access descriptor 1 and the direct memory access descriptor 2. Accordingly, when the direct memory access descriptor 3 is received, the latest second direct memory access descriptor at this time is equivalent to the merging result of the direct memory access descriptor 1 and the direct memory access descriptor 2, so the merging result of the direct memory access descriptor 3 and the latest second direct memory access descriptor is the merging result of the direct memory access descriptor 1, the direct memory access descriptor 2 and the direct memory access descriptor 3.

In the specific application scenario, in order to facilitate the execution of the merging operation, after acquiring the first direct memory access descriptor to be processed transmitted by the target accelerator function unit in the FPGA, and before acquiring the existing second direct memory access descriptor, it can also be determined whether the first direct memory access descriptor is the first direct memory access descriptor of the merging operation; If the first direct memory access descriptor is the first one of the direct memory access descriptor of the merging operation, taking the first direct memory access descriptor as the second direct memory access descriptor, and returning to the steps of acquiring the first direct memory access descriptor to be processed transmitted by the target accelerator function unit in the FPGA and the subsequent steps; If the first direct memory access descriptor is not the first one of the direct memory access descriptor of the merging operation, the step of acquiring the existing second direct memory access descriptor and subsequent steps are executed.

In practical application, in order to facilitate the operation of direct memory access descriptors, for example, to facilitate the processing and response of direct memory access descriptors, the target identification information of each first direct memory access descriptor of the merging operation may also be recorded.

In the specific application scenario, after the IP core of peripheral component interconnect express processes the second direct memory access descriptor, it will return the corresponding processing result, so after transmitting the second direct memory access descriptor to the IP core of peripheral component interconnect express in the FPGA for processing, it can also receive the first information transmitted by the IP core of peripheral component interconnect express, which represents that the processing of the second direct memory access descriptor is completed. And based on the target identification information, second information representing that the corresponding first direct memory access descriptor has been processed can be transmitted to the target accelerator function unit, to feed back the execution result of the direct memory access descriptor to the target accelerator function unit.

In the specific application scenario, in order to accurately process the execution result of the direct memory access descriptor, in the process of transmitting the second information representing that the corresponding first direct memory access descriptor has been processed to the target accelerator function unit based on the target identification information, the identification information of the second direct memory access descriptor in the second information can be parsed; If the identification information of the second direct memory access descriptor is consistent with the target identification information, the step of transmitting second information representing that the corresponding first direct memory access descriptor has been processed to the target accelerator function unit based on the target identification information is executed.

In the specific application scenario, in the process of recording the target identification information of each first direct memory access descriptor in the merging operation, in order to facilitate the recording of the target identification information, the first identifier of the first one of the first direct memory access descriptor in the merging operation can be recorded under the condition that the identification information among the first direct memory access descriptors is consecutive, and the numerical values of the first direct memory access descriptors merged in the merging operation can be recorded; The first identifier and the numerical values are used as the target identification information. Accordingly, in the process of transmitting the second information representing that the corresponding first direct memory access descriptor has been processed to the target accelerator function unit, the second information representing that the first direct memory access descriptor with the numerical value starting from the first identifier has been processed can be transmitted to the target accelerator function unit.

In the specific application scenario, in the process of transmitting the second direct memory access descriptor to the IP core of peripheral component interconnect express in the FPGA for processing, the second direct memory access descriptor can be transmitted to the IP core of peripheral component interconnect express through the first port of the IP core of peripheral component interconnect express for processing. The data structure of the direct memory access descriptor can be determined according to actual needs. For example, 0 to 63 bit of the direct memory access descriptor may be the source physical address of the direct memory access data, that is, the internal random memory address in the FPGA; 64 to 127 bit may be the destination physical address of direct memory access data, that is, the physical address of host memory in the FPGA; 128 to 145 bit may be the length of direct memory access data, and the unit can be bytes; 146 to 153 bit may be identification information of a direct memory access descriptor, etc.

In the specific application scenario, in the process of receiving the first information, representing the processing of the second direct memory access descriptor is completed transmitted by the IP core of peripheral component interconnect express, the first information, representing the processing of the second direct memory access descriptor is completed, transmitted by the IP core of peripheral component interconnect express can be received through the second port of the IP core of peripheral component interconnect express. The data structure of the first information can be determined according to the actual needs, for example, 0 to 7 bit of the first information can be the identification information of the direct memory access descriptor; 8 to 30 bit can be reserved bits, which is meaningless; 31 bit can be a success flag of the direct memory access descriptor, 0 means that the direct memory access operation is successful, 1 means that the direct memory access operation fails, and so on.

In specific application scenarios, in order to understand the processing progress of the direct memory access descriptor, the processing state of the first direct memory access descriptor can also be recorded by the state machine.

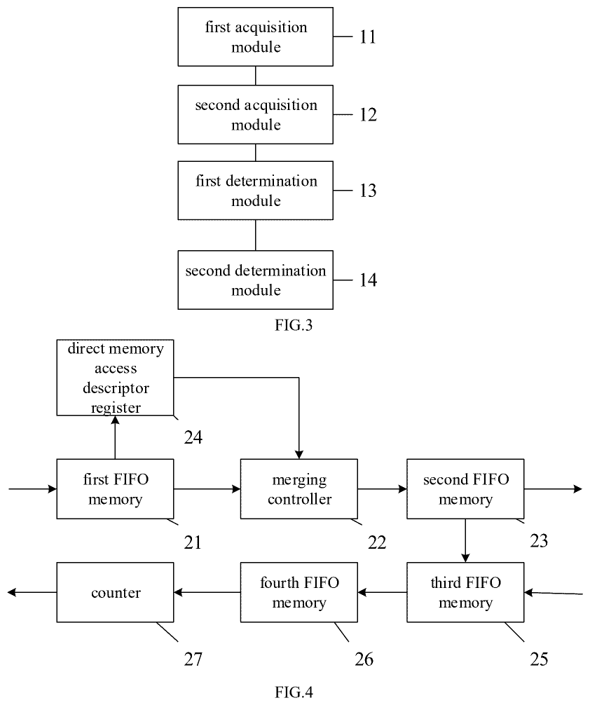

Please refer to FIG. 3, which is a structural schematic diagram of a direct memory access descriptor processing system provided by an embodiment of the present disclosure.

A direct memory access descriptor processing system provided by some embodiments of the present disclosure may include:
a first acquisition module 11, configured to acquire a first direct memory access descriptor to be processed transmitted by a target accelerator function unit in a FPGA;
a second acquisition module 12, configured to acquire an existing second direct memory access descriptor;
a first determination module 13, configured to determine whether the first direct memory access descriptor and the second direct memory access descriptor can be merged; if the first direct memory access descriptor and the second direct memory access descriptor can be merged, merging the first direct memory access descriptor into the second direct memory access descriptor;
a second determination module 14, configured to determine whether to terminate the merging operation; if the merging operation is not terminated, returning to execute a step of acquiring the first direct memory access descriptor to be processed transmitted by the target accelerator function unit in the FPGA and subsequent steps; if the merging operation is terminated, transmitting the second direct memory access descriptor to an IP core of PCI-E in the FPGA for processing.

In a direct memory access descriptor processing system provided by some embodiments of the present disclosure, the first determination module can be specifically configured to: acquire a last merged tail direct memory access descriptor in the second direct memory access descriptor; determine whether the tail direct memory access descriptor and the first direct memory access descriptor can be merged; determine that the first direct memory access descriptor and the second direct memory access descriptor can be merged if the tail direct memory access descriptor and the first direct memory access descriptor can be merged; and determine that the first direct memory access descriptor and the second direct memory access descriptor cannot be merged if the tail direct memory access descriptor and the first direct memory access descriptor cannot be merged.

In a direct memory access descriptor processing system provided by some embodiments of the present disclosure, a first determination module can be specifically configured to: parse a first source address, a first destination address and a first data length value in the tail direct memory access descriptor; calculate a sum of the first source address and the first data length value as a first expected source address; calculate a sum of the first destination address and the first data length value as a first expected destination address; parse a second source address and a second destination address in the first direct memory access descriptor; if the first expected source address is consistent with the second source address and the first expected destination address is consistent with the second destination address, determine that the tail direct memory access descriptor and the first direct memory access descriptor can be merged; if the first expected source address is inconsistent with the second source address and/or the first expected destination address is inconsistent with the second destination address, determine that the tail direct memory access descriptor and the first direct memory access descriptor cannot be merged.

In a direct memory access descriptor processing system provided by some embodiments of the present disclosure, the first determination module can be specifically configured to store the first direct memory access descriptor as a latest tail direct memory access descriptor after merging the first direct memory access descriptor into the second direct memory access descriptor.

In a direct memory access descriptor processing system provided by some embodiments of the present disclosure, a first determination module can be specifically configured to parse a third source address, a third destination address and a third data length value in the second direct memory access descriptor; calculate a sum of the third source address and the third data length value as a second expected source address; calculate a sum of the third destination address and the third data length value as a second expected destination address; parse a second source address and a second destination address in the first direct memory access descriptor; determine that the first direct memory access descriptor and the second direct memory access descriptor can be merged if the second expected source address is consistent with the second source address and the second expected destination address is consistent with the second destination address; and determine that the first direct memory access descriptor and the second direct memory access descriptor cannot be merged if the second expected source address is inconsistent with the second source address and/or the second expected destination address is inconsistent with the second destination address.

In a direct memory access descriptor processing system provided by some embodiments of the present disclosure, the second determination module can be specifically configured to: parse a third data length value in the second direct memory access descriptor; parse a second data length value in the first direct memory access descriptor; calculate a sum of the third data length value and the second data length value; keep a source address and a destination address of the second direct memory access descriptor unchanged, and taking the sum as a latest data length value of the second direct memory access descriptor.

In a direct memory access descriptor processing system provided by some embodiments of the present disclosure, an initial second direct memory access descriptor is empty, and setting a merging result of the initial second direct memory access descriptor and a first one of the first direct memory access descriptor of the merging operation as the first direct memory access descriptor itself.

A direct memory access descriptor processing system provided by some embodiments of the present disclosure may further include:
a third determination module, configured to determine whether the first direct memory access descriptor is the first one of the direct memory access descriptor of the merging operation after the first acquisition module acquires the first direct memory access descriptor to be processed transmitted by the target accelerator function unit in the FPGA and before the second acquisition module acquires the existing second direct memory access descriptor; if the first direct memory access descriptor is the first one of the direct memory access descriptor of the merging operation, take the first direct memory access descriptor as the second direct memory access descriptor, and return to execute steps after acquiring the first direct memory access descriptor to be processed transmitted by the target accelerator function unit in the FPGA; if the first direct memory access descriptor is not the first one of the direct memory access descriptor of the merging operation, execute steps after acquiring the existing second direct memory access descriptor.

A direct memory access descriptor processing system provided by some embodiments of the present disclosure may further include:
a recording module, configured to record target identification information of each of the first direct memory access descriptors of the merging operation.

A direct memory access descriptor processing system provided by some embodiments of the present disclosure may further include:
a receiving module, configured to receive the first information representing that processing of the second direct memory access descriptor completes after the second determination module transmits the second direct memory access descriptor to the IP core of peripheral component interconnect express in the FPGA for processing;
a transmission module, configured to transmit, based on the target identification information, second information representing that the processing of a corresponding first direct memory access descriptor has been completed to the target accelerator function unit.

In a direct memory access descriptor processing system provided by some embodiments of the present disclosure, the transmission module can be specifically configured to: parse identification information of the second direct memory access descriptor in the second information; if the identification information of the second direct memory access descriptor is consistent with the target identification information, execute a step of transmitting, based on the target identification information, the second information representing that the processing of the corresponding first direct memory access descriptor has been completed.

In a direct memory access descriptor processing system provided by some embodiments of the present disclosure, the recording module can be specifically configured to: if the identification information among each of the first direct memory access descriptors is consecutive, record the first identifier of the first one of the first direct memory access descriptor in the merging operation and recording numerical values of the first direct memory access descriptors merged in the merging operation; take the first identifier and the numerical values as the target identification information.

In a direct memory access descriptor processing system provided by some embodiments of the present disclosure, the second determination module can be specifically configured to transmit the second direct memory access descriptor to the IP core of peripheral component interconnect express for processing through a first port of the IP core of peripheral component interconnect express.

In a direct memory access descriptor processing system provided by some embodiments of the present disclosure, the receiving module can be specifically configured to receive the first information representing that processing of the second direct memory access descriptor completes transmitted by the IP core of peripheral component interconnect express through a second port of the IP core of peripheral component interconnect express.

A direct memory access descriptor processing system provided by some embodiments of the present disclosure may further include:
a state machine module, configured to record a processing state of the first direct memory access descriptor by a state machine.

In a direct memory access descriptor processing system provided by some embodiments of the present disclosure, the first determination module can also be configured to: after determining whether the first direct memory access descriptor and the second direct memory access descriptor can be merged, if the first direct memory access descriptor and the second direct memory access descriptor cannot be merged, transmitting the second direct memory access descriptor to the IP core of peripheral component interconnect express for processing, taking the first direct memory access descriptor as the second direct memory access descriptor, and returning to execute a step of acquiring the first direct memory access descriptor to be processed transmitted by the target accelerator function unit in the FPGA and subsequent steps.

Please refer to FIG. 4, which is a structural schematic diagram of a direct memory access descriptor processing apparatus provided by an embodiment of the present disclosure.

A direct memory access descriptor processing apparatus provided by some embodiments of the present disclosure may include:
a first FIFO memory 21 connected to a target accelerator function unit in a FPGA, configured to store a first direct memory access descriptor to be processed transmitted by the target accelerator function unit;
a merging controller 22 connected to the first FIFO memory and a second FIFO memory, configured to determine whether the first direct memory access descriptor and a second direct memory access descriptor stored in the second FIFO can be merged; merge the first direct memory access descriptor and the second direct memory access descriptor stored in the second FIFO memory if the first direct memory access descriptor and the second direct memory access descriptor can be merged; determine whether to terminate the merging operation; if the merging operation is not terminated, after the first direct memory access descriptor stored in the first FIFO memory is updated, return to execute a step of determining whether the first direct memory access descriptor and the second direct memory access descriptor can be merged and subsequent steps; if the merging operation is terminated, transmit the second direct memory access descriptor stored in the second FIFO memory to an Intellectual Property core (IP core) of peripheral component interconnect express in a field programmable gate array (FPGA) for processing;
the second FIFO memory 23, configured to store the existing second direct memory access descriptor.

A direct memory access descriptor processing apparatus provided by some embodiments of the present disclosure may further include:
a direct memory access descriptor register 24 connected to the first FIFO memory and the merging controller, configured to store the first direct memory access descriptor as a latest tail direct memory access descriptor.

A direct memory access descriptor processing apparatus provided by some embodiments of the present disclosure may further include:
a third FIFO memory 25 connected to the second FIFO memory, configured to record target identification information of each of the first direct memory access descriptors in the merging operation; In specific application scenarios, the data structure of the third FIFO memory can be 0-7 bits to record the identification information, 8-23 bits to record the numerical values of the merged direct memory access descriptor, etc.

A fourth FIFO memory 26 connected to the third FIFO memory, configured to record numerical values of the first direct memory access descriptor merged by the merging operation; In specific application scenarios, the data structure of the fourth FIFO memory can be 0-7 bits to record identification information, 8-23 bits to record numerical values of the merged direct memory access descriptor, and 24 bit to record a flag indicating whether the direct memory access descriptor is successfully processed.

A counter 27 connected to the fourth FIFO memory and the target accelerator function unit, configured to record a quantity value of second information transmitted to the target accelerator function unit, which represents that processing of a corresponding first direct memory access descriptor has been completed.

The corresponding descriptions of the direct memory access descriptor processing apparatus provided by some embodiments of the present disclosure can refer to the above embodiments, and are not repeated here.

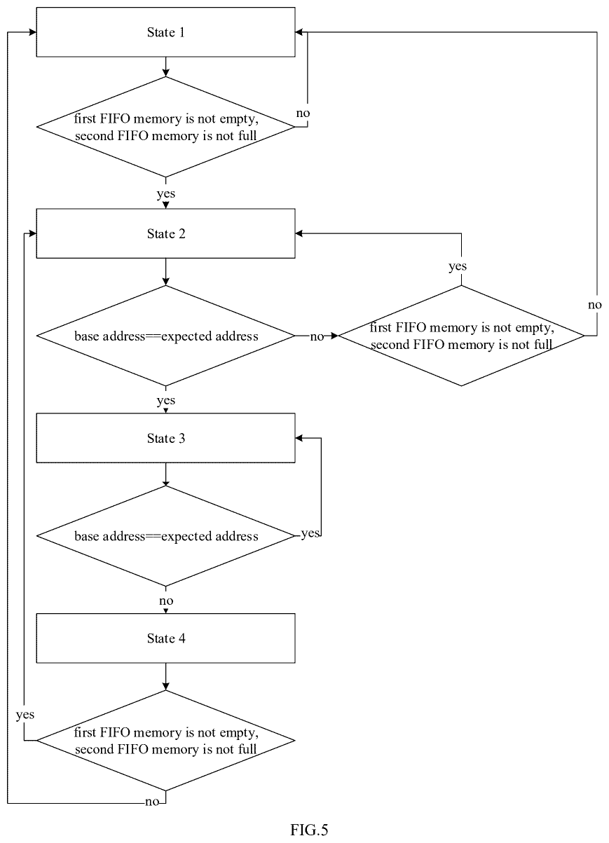

It should be noted that the state machine of the direct memory access descriptor processing apparatus can be as shown in FIG. 5. The initial state of the state machine is state 1. When the first FIFO memory is not empty and the second FIFO memory is not full, the data of the first FIFO memory is read into the direct memory access descriptor register and jumps to state 2. Otherwise, keep state 1. State 2, when it is determined that the first FIFO memory is not empty and the source address and destination address of the output port are consistent with the expected source address and destination address of the direct memory access descriptor register, jump to state 3 and read the data of the first FIFO memory into the direct memory access descriptor register; If the previous condition is not met, and the first FIFO memory is empty or the second FIFO memory is full, jump to state 1, do not read the first FIFO memory, and write the direct memory access descriptor register data into the second FIFO memory; If the above two conditions are not met, keep the state 1, read the first FIFO memory data into the direct memory access descriptor register, and write the direct memory access descriptor register data into the second FIFO memory. State 3, it is determined that the first FIFO memory is empty, or the source address of the output port of the first FIFO memory is inconsistent with the expected source address of the direct memory access descriptor register, or the destination address of the output port of the first FIFO memory is inconsistent with the expected destination address of the direct memory access descriptor register, or the combined number counter reaches a set upper limit, and jump to state 4; If the above conditions are not met, keep state 3 and read the first FIFO memory data to the direct memory access descriptor register. In state 4, the merged direct memory access descriptor is written into the second FIFO memory, and when it is determined that the first FIFO memory is not empty and the second FIFO memory is not full, jump to state 2 and read the data of the first first FIFO memory into the direct memory access descriptor register; Otherwise, jump to state 1.

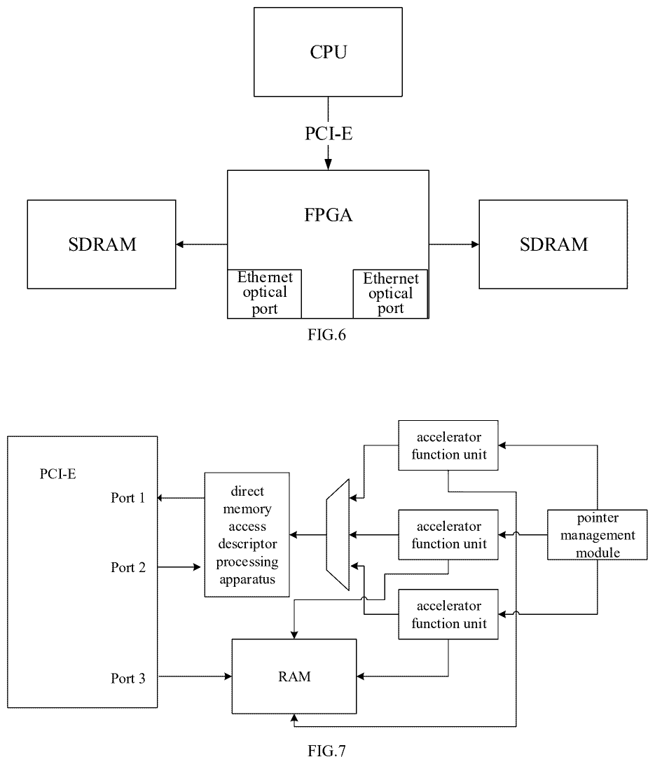

In order to facilitate the understanding of the working flow of the direct memory access descriptor processing apparatus in the present disclosure, it will now be described in combination with the scenes in FIG. 6 and FIG. 7. In FIG. 6, two 10G Ethernet optical ports and two 4 GB SDRAM (Synchronous Dynamic Random Access Memory) are connected to the FPGA as memories, and the central processor of the server can be connected by PCI-E. In FIG. 7, the FPGA includes three accelerated computing units, including a pointer management module, a IP core of PCI-E, a descriptor channel merging module, a random access memory and the apparatus of the present disclosure, wherein the pointer management module internally stores the source address, destination address and identification information of direct memory access operation, and each source address and destination address are separated by 1024 bytes, and the identification information is a continuous increasing sequence with an interval of 1. The function of descriptor channel merging module is to merge the three direct memory access descriptors and send them as one, and receive the completion information of direct memory access operation and return it to the corresponding direct memory access descriptor sending module; The working flow of the direct memory access descriptor processing apparatus in the present disclosure is as follows.

The three accelerator function units perform different types of calculations on the original data at the same time, and the length of the calculated result data is 1024 bytes. Then, the identifier, source address and destination address of the direct memory access operation are sequentially acquired from the pointer management module, and the result data are stored in the internal random access memory of the FPGA according to the source address, and the direct memory access descriptor is issued according to the identification information, source address and destination address to transmit the result data to the host memory. It should be noted that since the three acceleration calculation units use the same pointer management module, and the length of the three result data is 1024 bytes, the three result data are continuously stored in the internal random access memory of the FPGA and the host memory;

The direct memory access descriptors sent by the three accelerator function units are successively and continuously input into the apparatus of the present disclosure by the channel merging module, and are first stored in the first FIFO memory. The state machine of the merging controller jumps from state 1 to state 2, and the first direct memory access descriptor is read from the first FIFO memory and stored in the direct memory access descriptor register. In state 2, the data stored in the direct memory access descriptor register is calculated to acquire the expected source address and expected destination address of the first one of the direct memory access descriptor, which are consistent with the source address and destination address of the second one of the direct memory access descriptor of the first FIFO memory output port, and then jump to state 3 to acquire the merged direct memory access descriptor. And the source address, destination address and identifier of the merged direct memory access descriptor are the source address, destination address and identifier of the first one of the direct memory access descriptor, and the length is the sum of the lengths of the first one of the direct memory access descriptor and the second one of the direct memory access descriptor, and the second one of the direct memory access descriptor is read out from the first FIFO memory and stored in the direct memory access descriptor register. In state 3, the data stored in the direct memory access descriptor register is calculated to acquire the expected source address and expected destination address of the second one of the direct memory access descriptor, which are consistent with the source address and destination address of the third direct memory access descriptor of the first FIFO memory output port, and the state 3 is maintained. The source address, destination address and identifier of the new merged direct memory access descriptor are kept as those of the current merged direct memory access descriptor, and the length of the new merged direct memory access descriptor is the length of the current merged direct memory access descriptor plus the length of the third direct memory access descriptor, and the third direct memory access descriptor is read out from the first first FIFO memory and stored in the direct memory access descriptor register. In state 3, it is determined that the first FIFO memory is empty, and jump to state 4. In state 4, write the merged direct memory access descriptor into the second FIFO memory, determine that the first FIFO memory is empty, and jump to state 1. The second FIFO memory sends the merged direct memory access descriptor to port 1 of the IP core of peripheral component interconnect express, and writes the identifier of the merged direct memory access descriptor and the number of merging (3) into the third FIFO memory.

The IP core of peripheral component interconnect express performs a direct memory access (DMA) transfer of three computation result data stored in the FPGA internal random access memory to the host memory, based on the merged DMA descriptor. After the direct memory access operation is successful, the port 2 of the IP core of peripheral component interconnect express returns the completion information to the apparatus module of the present disclosure. The apparatus module of the present disclosure compares the identifier of the returned direct memory access completion information with the identifier of the output port of the third FIFO memory, determines that the numerical values are consistent, reads data from the third FIFO memory, and writes the success flag of the returned direct memory access completion information, the merging number and the identifier of the direct memory access descriptor into the fourth FIFO memory.

After the fourth FIFO memory is not empty, read a piece of data from the fourth FIFO memory. It is determined that the merged direct memory access descriptor output by the fourth FIFO is 3, and three pieces of direct memory access completion information are continuously output to the downstream module. The identifier of the first direct memory access completion information is the identifier output by the fourth FIFO memory, the identifier of the second and third output completion information is the first identifier plus 1 and 2, and the flag signals for recording whether the direct memory access descriptors are successfully processed in the three direct memory access completion information are all the flag signals for recording whether the direct memory access descriptors are successfully processed output by the fourth FIFO memory.

After receiving three direct memory access completion information, the descriptor channel merging module returns the direct memory access completion information to the three accelerator function units respectively. So far, the operation of direct memory accessing the calculation result data into the host memory is completed.

The present disclosure also provides an electronic device and a non-transitory readable storage medium, both of which have the corresponding effects of the direct memory access descriptor processing method provided by the embodiment of the present disclosure. Please refer to FIG. 8, which is a structural schematic diagram of an electronic device provided by an embodiment of the present disclosure.

An electronic device provided by an embodiment of the present disclosure comprises a memory 201 and a processor 202, wherein a computer program is stored in the memory 201, and the processor 202 implements the steps of the direct memory access descriptor processing method as described in any embodiment when executing the computer program.

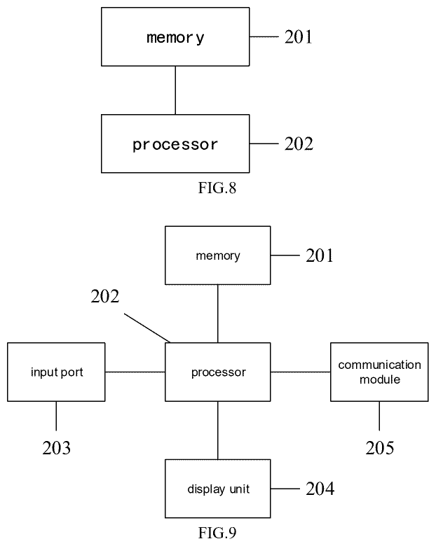

Referring to FIG. 9, another electronic device provided by some embodiments of the present disclosure may further include an input port 203 connected to the processor 202 for transmitting commands input from the outside to the processor 202; A display unit 204 connected to the processor 202, for displaying the processing result of the processor 202 to the outside; A communication module 205 connected to the processor 202 is used to realize the communication between the electronic equipment and the outside world. The display unit 204 can be a display panel, a laser scanning display, etc. The communication modes adopted by the communication module 205 include, but are not limited to, mobile high-definition link technology (MHL), universal serial bus (USB), high-definition multimedia interface (HDMI), wireless connection: wireless fidelity technology (WiFi), Bluetooth communication technology, low-power Bluetooth communication technology and communication technology based on IEEE802.11s.

An embodiment of the present disclosure provides a non-transitory readable storage medium in which a computer program is stored, and when the computer program is executed by a processor, the steps of the direct memory access descriptor processing method described in any embodiment are implemented.

The non-transitory readable storage medium involved in the present disclosure includes a random access memory (RAM), an internal memory, a read-only memory (ROM), an electrically programmable ROM, an electrically erasable programmable ROM, registers, hard disks, removable disks, CD-ROMs, or any other storage medium known in the technical field.

For the description of the relevant parts in the direct memory access descriptor processing system, apparatus, electronic device and non-transitory readable storage medium provided by the embodiments of the present disclosure, please refer to the detailed description of the corresponding parts in the direct memory access descriptor processing method provided by the embodiments of the present disclosure, and will not be repeated here. In addition, the part of the above technical solution provided by the embodiments of the present disclosure that is consistent with the realization principle of the corresponding technical solution in the prior art is not described in detail, to avoid redundant description.

It should also be noted that in this disclosure, relational terms such as first and second are only used to distinguish one entity or operation from another entity or operation, and do not necessarily require or imply that there is any such actual relationship or order between these entities or operations. Moreover, the terms “including”, “containing” or any other variation thereof are intended to cover non-exclusive inclusion, so that a process, method, article or equipment including a series of elements includes not only those elements, but also other elements not explicitly listed or elements inherent to such process, method, article or equipment. Without further restrictions, an element defined by the phrase “including one” does not exclude the existence of other identical elements in the process, method, article or equipment including the element.

The foregoing description of the disclosed embodiments enables any person skilled in the art to make or use the present disclosure. Many modifications to these embodiments will be obvious to those skilled in the art, and the general principles defined herein can be implemented in other embodiments without departing from the spirit or scope of the present disclosure. Therefore, the present disclosure will not be limited to the embodiments shown herein, but is to be accorded the widest scope consistent with the principles and novel features disclosed herein.

1. A direct memory access descriptor processing method, comprising:
acquiring a first direct memory access descriptor to be processed transmitted by a target accelerator function unit in a field programmable gate array (FPGA) ;
acquiring an existing second direct memory access descriptor;
determining whether the first direct memory access descriptor and the second direct memory access descriptor can be merged;
if the first direct memory access descriptor and the second direct memory access descriptor can be merged, merging the first direct memory access descriptor into the second direct memory access descriptor;
determining whether to terminate the merging operation;
if the merging operation is not terminated, returning to execute a step of acquiring the first direct memory access descriptor to be processed transmitted by the target accelerator function unit in the FPGA and subsequent steps;
if the merging operation is terminated, transmitting the second direct memory access descriptor to an Intellectual Property core (IP core) of peripheral component interconnect express (PCI-E) in the FPGA for processing;
wherein merging the first direct memory access descriptor into the second direct memory access descriptor comprises:
parsing a third data length value in the second direct memory access descriptor;
parsing a second data length value in the first direct memory access descriptor;
calculating a sum of the third data length value and the second data length value;
keeping a source address and a destination address of the second direct memory access descriptor unchanged, and taking the sum as a latest data length value of the second direct memory access descriptor.

2. The method according to claim 1, wherein determining whether the first direct memory access descriptor and the second direct memory access descriptor can be merged comprises:
acquiring a last merged tail direct memory access descriptor in the second direct memory access descriptor;
determining whether the tail direct memory access descriptor and the first direct memory access descriptor can be merged;
determining that the first direct memory access descriptor and the second direct memory access descriptor can be merged if the tail direct memory access descriptor and the first direct memory access descriptor can be merged;
determining that the first direct memory access descriptor and the second direct memory access descriptor cannot be merged if the tail direct memory access descriptor and the first direct memory access descriptor cannot be merged.

3. The method according to claim 2, wherein determining whether the tail direct memory access descriptor and the first direct memory access descriptor can be merged comprises:
parsing a first source address, a first destination address and a first data length value in the tail direct memory access descriptor;
calculating a sum of the first source address and the first data length value as a first expected source address;
calculating a sum of the first destination address and the first data length value as a first expected destination address;
parsing a second source address and a second destination address in the first direct memory access descriptor;
if the first expected source address is consistent with the second source address and the first expected destination address is consistent with the second destination address, determining that the tail direct memory access descriptor and the first direct memory access descriptor can be merged;
if the first expected source address is inconsistent with the second source address and/or the first expected destination address is inconsistent with the second destination address, determining that the tail direct memory access descriptor and the first direct memory access descriptor cannot be merged.

4. The method according to claim 3, wherein after merging the first direct memory access descriptor into the second direct memory access descriptor, the method further comprises:
storing the first direct memory access descriptor as a latest tail direct memory access descriptor.

5. The method according to claim 1, wherein determining whether the first direct memory access descriptor and the second direct memory access descriptor can be merged comprises:
parsing a third source address, a third destination address and a third data length value in the second direct memory access descriptor;
calculating a sum of the third source address and the third data length value as a second expected source address;
calculating a sum of the third destination address and the third data length value as a second expected destination address;
parsing a second source address and a second destination address in the first direct memory access descriptor;
determining that the first direct memory access descriptor and the second direct memory access descriptor can be merged if the second expected source address is consistent with the second source address and the second expected destination address is consistent with the second destination address;
determining that the first direct memory access descriptor and the second direct memory access descriptor cannot be merged if the second expected source address is inconsistent with the second source address and/or the second expected destination address is inconsistent with the second destination address.

6. (canceled)

7. The method according to claim 6, wherein an initial second direct memory access descriptor is empty, and setting a merging result of the initial second direct memory access descriptor and a first one of the first direct memory access descriptor of the merging operation as the first direct memory access descriptor itself.

8. The method according to claim 6, wherein after acquiring the first direct memory access descriptor to be processed transmitted by the target accelerator function unit in the FPGA, and before acquiring the existing second direct memory access descriptor, the method further comprises:
determining whether the first direct memory access descriptor is the first one of the direct memory access descriptor of the merging operation;
if the first direct memory access descriptor is the first one of the direct memory access descriptor of the merging operation, taking the first direct memory access descriptor as the second direct memory access descriptor, and returning to execute steps after acquiring the first direct memory access descriptor to be processed transmitted by the target accelerator function unit in the FPGA;
if the first direct memory access descriptor is not the first one of the direct memory access descriptor of the merging operation, executing steps after acquiring the existing second direct memory access descriptor.

9. The method according to claim 8, further comprising:
recording target identification information of each of the first direct memory access descriptors of the merging operation.

10. The method according to claim 9, wherein after transmitting the second direct memory access descriptor to the IP core of peripheral component interconnect express in the FPGA for processing, the method further comprises:
receiving first information representing that processing of the second direct memory access descriptor completes transmitted by the IP core of peripheral component interconnect express;
transmitting, based on the target identification information, second information representing that the processing of a corresponding first direct memory access descriptor has been completed to the target accelerator function unit.

11. The method according to claim 10, wherein transmitting, based on the target identification information, the second information representing that the processing of the corresponding first direct memory access descriptor has been completed to the target accelerator function unit comprises:
parsing identification information of the second direct memory access descriptor in the second information;
if the identification information of the second direct memory access descriptor is consistent with the target identification information, executing a step of transmitting, based on the target identification information, the second information representing that the processing of the corresponding first direct memory access descriptor has been completed.

12. The method according to claim 11, wherein recording the target identification information of each of the first direct memory access descriptors of the merging operation comprises:
if the identification information among each of the first direct memory access descriptors is consecutive, recording the first identifier of the first one of the first direct memory access descriptor in the merging operation and recording numerical values of the first direct memory access descriptors merged in the merging operation;
taking the first identifier and the numerical values as the target identification information.

13. The method according to claim 12, wherein transmitting the second direct memory access descriptor to the IP core of peripheral component interconnect express in the FPGA for processing comprises:
transmitting the second direct memory access descriptor to the IP core of peripheral component interconnect express for processing through a first port of the IP core of peripheral component interconnect express.

14. The method according to claim 13, wherein receiving the first information representing that processing of the second direct memory access descriptor completes transmitted by the IP core of peripheral component interconnect express comprises:
receiving the first information representing that processing of the second direct memory access descriptor completes transmitted by the IP core of peripheral component interconnect express through a second port of the IP core of peripheral component interconnect express.

15. The method according to claim 1, further comprising:
recording a processing state of the first direct memory access descriptor by a state machine.

16. The method according to claim 1, wherein after determining whether the first direct memory access descriptor and the second direct memory access descriptor can be merged, the method further comprises:
if the first direct memory access descriptor and the second direct memory access descriptor cannot be merged, transmitting the second direct memory access descriptor to the IP core of peripheral component interconnect express for processing, taking the first direct memory access descriptor as the second direct memory access descriptor, and returning to execute a step of acquiring the first direct memory access descriptor to be processed transmitted by the target accelerator function unit in the FPGA and subsequent steps.

17. (canceled)

18. A direct memory access descriptor processing apparatus, comprising:
a first first-in first-out (FIFO) memory connected to a target accelerator function unit in a field programmable gate array (FPGA), configured to store a first direct memory access descriptor to be processed transmitted by the target accelerator function unit;
a merging controller connected to the first FIFO memory and a second FIFO memory, configured to determine whether the first direct memory access descriptor and a second direct memory access descriptor stored in the second FIFO can be merged; merge the first direct memory access descriptor and the second direct memory access descriptor stored in the second FIFO memory if the first direct memory access descriptor and the second direct memory access descriptor can be merged; determine whether to terminate the merging operation; if the merging operation is not terminated, after the first direct memory access descriptor stored in the first FIFO memory is updated, return to execute a step of determining whether the first direct memory access descriptor and the second direct memory access descriptor can be merged and subsequent steps; if the merging operation is terminated, transmit the second direct memory access descriptor stored in the second FIFO memory to an Intellectual Property core (IP core) of peripheral component interconnect express in a field programmable gate array (FPGA) for processing;
the second FIFO memory, configured to store the existing second direct memory access descriptor;
wherein the merging controller is further configured to parse a third data length value in the second direct memory access descriptor; parse a second data length value in the first direct memory access descriptor; calculate a sum of the third data length value and the second data length value; and keep a source address and a destination address of the second direct memory access descriptor unchanged, and taking the sum as a latest data length value of the second direct memory access descriptor.

19. The apparatus according to claim 18, further comprising:
a direct memory access descriptor register connected to the first FIFO memory and the merging controller, configured to store the first direct memory access descriptor as a latest tail direct memory access descriptor.

20. The apparatus according to claim 19, further comprising:
a third FIFO memory connected to the second FIFO memory, configured to record target identification information of each of the first direct memory access descriptors in the merging operation;
a fourth FIFO memory connected to the third FIFO memory, configured to record numerical values of the first direct memory access descriptor merged by the merging operation;
a counter connected to the fourth FIFO memory and the target accelerator function unit, configured to record a quantity value of second information transmitted to the target accelerator function unit, which represents that processing of a corresponding first direct memory access descriptor has been completed.

21. An electronic device, comprising:
a memory, configured to store a computer program;
a processor, configured to implement steps of the direct memory access descriptor processing method according to claim 1 when execute the computer program.

22. A non-transitory readable storage medium, wherein a computer program is stored in the non-transitory readable storage medium, and the computer program, when executed by a processor, implements steps of the direct memory access descriptor processing method according to claim 1.
